(19) United States
(12) Patent Application Publication
(10) Pub. No.: US 2008/0059417 A1
(43) Pub. Date: Mar. 6, 2008

(54) Structured document management system and method of managing indexes in the same system

(76) Inventors: Akitomo Yamada, Koganei-shi (JP); Hitoshi Tanigawa, Higashiyamato-shi (JP); Katsufumi Fujimoto, Fuchu-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/892,781

(22) Filed: Aug. 27, 2007

(30) Foreign Application Priority Data
Aug. 28, 2006 (JP) 2006-231012

(51) Int. Cl. G06F 17/30

(52) U.S. Cl. 707/2; 707/E17.002

(57) ABSTRACT

On the basis of an index generation request which is sent from the outside to direct generation of character string concatenation index and which designates a tag assigned the generated character string concatenation index, a tag detection unit detects the tag designated by the index generation request, in a structured document which is newly stored or has already been stored in a document storing area. An index management unit generates the character string concatenation index assigned to the detected tag and stores the generated character string concatenation index in an index storing area. The generated character string concatenation index includes values of a plurality of text nodes concatenated. The text nodes are included in the structured document having the detected tag and depend on the detected tag.

### CROSS-REFERENCE TO RELATED APPLICATIONS

This application is based upon and claims the benefit of priority from prior Japanese Patent Application No. 2006-231012, filed Aug. 28, 2006, the entire contents of which are incorporated herein by reference.

### BACKGROUND OF THE INVENTION

1. Field of the Invention

The present invention relates to a structured document management system and, more particularly, to a structured document management system suitable for management of indexes used to search structured documents and a method of managing the indexes in the same system.

2. Description of the Related Art

A document represented in the Extensible Markup Language (XML) form is called an XML document. In a structured document represented by the XML document, a hierarchy structure is expressed by a string called tag. More specifically, the text is structured by surrounding the text with a couple of tags (i.e. a couple of a start tag and an end tag). The string from the start tag to the end tag is called an element including the tags. The string surrounded by the start tag and the end tag is called the content of a element. The structured document (XML document) can be expressed by a tree structure. In the tree structure of the structured document, a node corresponding to the element of the structured document is called an element node. If the content (value) of the element is the text, the node corresponding to the content of the element is called a text node. The text node is composed of the text alone. In other words, the text node, the value of the text node and the text are equivalent to each other.

A system of managing a number of structured documents and executing large-scale search processing is called a structured document management system. A database management system (DBMS) operated in the database server is known as a typical structured document management system. In the structured document management system, a method of improving a search speed by using indexes (index data) is applied as disclosed in, for example, JP-A No. 2000-207409 (KOKAI) and JP-A No. 2006-172268 (KOKAI). The indexes are used to accelerate the speed of the search using the data (value) in the structured document.

In the structured document management system, the structured document is often searched in units of element node. Thus, the index is generally assigned in units of element node. Then, assignment of the index in units of element node will be exemplified. First, an XML document including the following data in which a Japanese address is described in the XML form is assumed.

<address>

<prefecture> Tokyo </prefecture>
<municipality> Fuchu-shi Musashidai </municipality>
<number> 1-1-15 </number>

</address>

To search such an XML document, a first condition [address contains “Tokyo Fuchu-shi”] is used. “Tokyo Fuchu-shi” is a Japanese inscription expressed with Roman letters and corresponds to an alphabetical inscription “Fuchu-shi, Tokyo”. “shi” of “Fuchu-shi” corresponds to English word “municipality”.

A client terminal issues a search request for searching under the first condition, to the structured document management system. This search request includes, for example, “/address[prefecture/text( )=“Tokyo” and contains (municipality/text( ), “Fuchu-shi”)]” as a search character string (query). To accelerate the XML document search of such queries, indexes are generated and assigned to the element nodes (<prefecture> tag and <municipality> tag) specified by path [/address/prefecture] and path [/address/municipality], respectively.

However, when accelerating the XML document search with the indexes generated in units of element node is aimed, the degree of freedom in the <address> tag is limited. The limitation in the degree of freedom of the tag is explained with, for example, the following DOCUMENT #1 and DOCUMENT #2 shown in FIG. 4A and FIG. 4B, respectively.

DOCUMENT #1:

<address>

<prefecture> Tokyo </prefecture>
<municipality> Fuchu-shi Musashidai </municipality>
<number> 1-1-15 </number>

</address>

DOCUMENT #2:

<address>

<prefecture> Tokyo </prefecture>
<ward> Minato-ku </ward>
<municipality> Shibaura </municipality>
<number> 1-1-1 </number>

</address>

Use of <ward> tag besides the <municipality> tag, in the XML document search using the indexes generated for the DOCUMENT #1 and the DOCUMENT #2 is assumed. More specifically, searching is executed under a second condition [address contains “Tokyo Minato-ku Shibaura”]. “Tokyo Minato-ku Shibaura” is a Japanese inscription expressed with Roman letters and corresponds to an alphabetical inscription “Shibaura, Minato-ku, Tokyo”. “ku” of “Minato-ku” corresponds to English word “ward”.

For the search under the second condition, for example, a query such as “/address [prefecture/text( )=“Tokyo” and ward/text( )=“Minato-ku” and contains (municipality/text( ), “Shibaura”)]” needs to be used. In this case, use of the query as used for the search under the first condition is difficult. In other words, for the search under the second condition, not only the condition values, but also the query need to be rewritten.

On the other hand, a desired search can be carried out by describing “/address [contains(., “Tokyo Minato-ku Shibaura”)]” in a path form called XPath to designate the hierarchy structure of the XML documents. According to the conventional technique of generating the indexes in units of element node, however, as the corresponding index is not present, it is necessary to search the content of each XML document and confirm whether the document meets the conditions. For this reason, it is difficult to carry out high-speed search.

When searching is executed by using the indexes generated in units of element node, AND merge processing needs to be executed. In the above example, the AND merge processing merges under the AND condition whether or not the result of hits using the index assigned to the <prefecture> tag, the result of hits using the index assigned to the <municipality> tag, and the result of hits using the index assigned to the <ward> tag are contained in the single document. In a case of hitting a large amount of data elements by the search using any one of indexes or all the indexes, the high-speed performance of the search may be damaged by the AND merge processing.

### BRIEF SUMMARY OF THE INVENTION

According to an embodiment of the present invention, there is provided a structured document management system. This system comprises a structured document database, a tag detection unit and an index management unit. The structured document database includes a structured document storing area in which a plurality of structured documents are stored and an index storing area in which indexes are stored. The indexes are used to search the structured documents stored in the structured document storing area. The tag detection unit is configured to detect, in accordance with an index generation request which is sent from an outside of the structured document management system to direct generation of a character string concatenation index and which designates a tag assigned the generated character string concatenation index, the tag designated by the index generation request, from the structured document which is newly stored or has already been stored in the structured document storing area. The index management unit is configured to generate a character string concatenation index assigned to the tag detected by the tag detection unit and store the generated character string concatenation index in the index storing area. The character string concatenation index includes values of a plurality of text nodes concatenated. The text nodes are included in the structured document having the detected tag and depend on the detected tag.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a hardware configuration of a client-server system containing a structured document management system according to an embodiment of the present invention;

FIG. 2 is a block diagram showing main functions of the structured document management system shown in FIG. 1;

FIG. 3 is a flowchart showing steps of an index setting process in the embodiment;

FIG. 4A and FIG. 4B are illustrations showing examples of XML documents;

FIG. 5 is an illustration showing a tree structure of the XML documents shown in FIG. 4A and FIG. 4B;

FIG. 6A is an index setting management table applied to the embodiment;

FIG. 6B is an index setting management table applied to a first modified example of the embodiment;

FIG. 7 is a flowchart showing steps of a document storing process in the embodiment;

FIG. 8 is an illustration showing association of indexes assigned to path “/address” in two documents shown in the tree structure of FIG. 5, with the tree structure;

FIG. 9 is an illustration showing a data structure of an index data array generated in the embodiment;

FIG. 10 is a flowchart showing steps of a document searching process in the embodiment;

FIG. 11 is an illustration showing a model of index generation applied to the embodiment;

FIG. 12 is an illustration showing a model of index generation applied to the first modified example of the embodiment;

FIG. 13 is an illustration showing association of indexes assigned to path “/address” in two documents shown in the tree structure of FIG. 5, with the tree structure, in the first modified example;

FIG. 14 is an illustration showing an example of an XML document applied to a second modified example of the embodiment, in a tree structure;

FIG. 15 is an illustration showing a data structure of an index data array generated in the second modified example;

FIG. 16 is a flowchart showing steps of an index searching process in the second modified example;

FIG. 17 is an illustration showing an example of an XML document applied to a third modified example of the embodiment, in a tree structure; and

FIG. 18 is a flowchart showing steps of executing type converting process during an index generation in a third modified example.

### DETAILED DESCRIPTION OF THE INVENTION

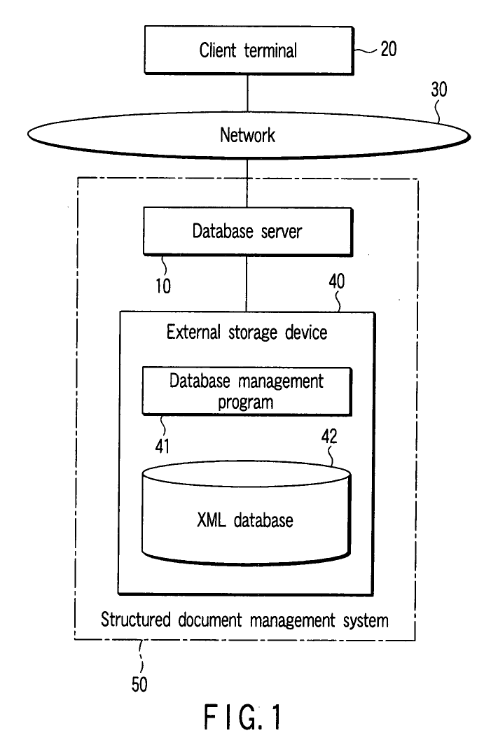

An embodiment of the present invention will be described below with reference to the accompanying drawings. FIG. 1 is a block diagram showing a hardware configuration of a client-server system containing a structured document management system according to an embodiment of the present invention. The client-server system mainly comprises a database server (database server computer) 10 and a plurality of client terminals. The client terminals contain a client terminal 20. In the client terminal 20, applications (application programs) using the database server 10 are operated. The client terminals containing the client terminal 20 are connected to the database server 10 via a network 30 such as a local area network (LAN). The client terminals other than the client terminal 20 are omitted in FIG. 1.

The database server 10 is connected to an external storage device 40 such as a hard disk drive. The external storage device 40 stores a database management program 41 and an XML database 42.

The database management program 41 is used for management of the XML database 42 by the database server 10, and a search process based on search requests from the client terminals. The XML database 42 is a structured document database configured to store XML documents (XML document data) which are structured documents. In the XML database 42, indexes generated on the basis of the XML documents stored in the XML database 42 are also stored.

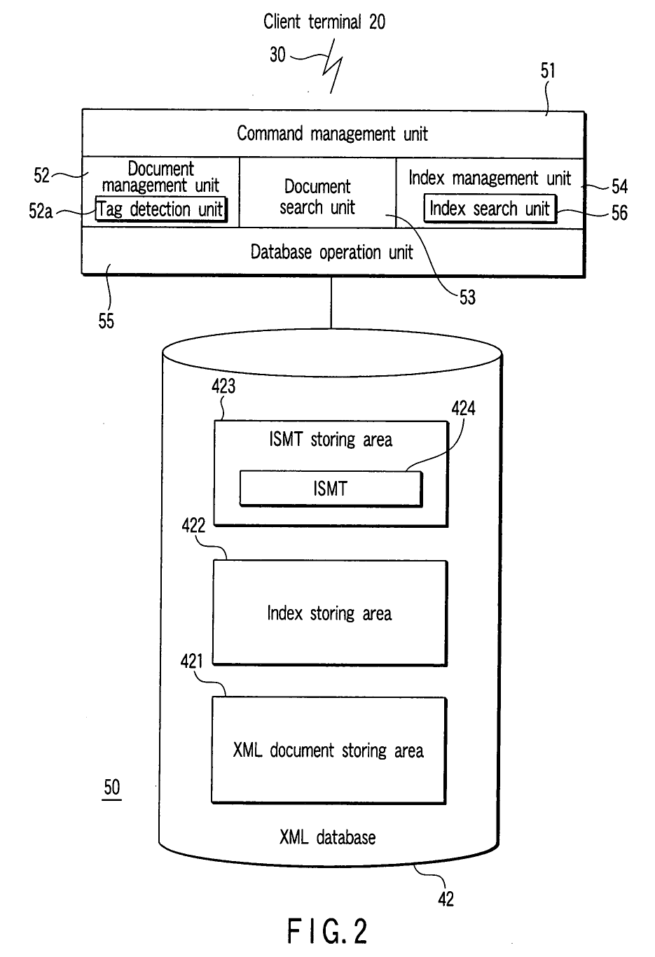

In the present embodiment, a structured document management system 50 is implemented by the database server 10 and the external storage device 40. FIG. 2 is a block diagram showing main functions of the structured document management system 50. The structured document management system 50 comprises a command management unit 51, a document management unit 52, a document search unit 53, an index management unit 54 and a database operation unit 55, besides the XML database 42. In the present embodiment, each of the units 51 to 55 is implemented by reading and executing, by the database server shown in FIG. 1., the database management program 41 stored in the external storage device 40. The program 41 can be prestored in a computer-readable storage medium and distributed. The program 41 may be downloaded to the database server 10 via the network 30.

In the XML database 42, an XML document storing area 421, an index storing area 422 and an index-setting-management-table (ISMT) storing area 423 are reserved. In the XML document storing area 421, a plurality of XML documents (XML document data) are stored. In the index storing area 422, indexes generated on the basis of XML documents which are to be newly stored or have already been stored in the XML document storing area 421 are stored. In the ISMT storing area 423, an index setting management table (ISMT) 424 is stored. The ISMT 424 is used to manage the generation of indexes which are to be stored in the index storing area 422.

The command management unit 51 accepts a command (request) given from the client terminal via the network 30 and determines a type of the command. In accordance with the determination result of the command type, the command management unit 51 causes any one of the document management unit 52, the document search unit 53, and the index management unit 54 to execute a process designated by the command.

The document management unit 52 executes management of XML documents in the XML document storing area 421 of the XML database 42 (XML document management). The XML document management includes a process of storing XML documents in the XML document storing area 421. The document management unit 52 comprises a tag detection unit 52a. The tag detection unit 52a detects an element (element node) including a tag designated with a setting path in index setting information to be described later, from the XML documents stored in the XML document storing area 421.

The document search unit 53 is so called a document search engine for searching the XML documents which meet the search condition designated by the search request, in the XML document storing area 421. The document search unit 53 uses the indexes stored in the index storing area 422 of the XML database 42, for the XML document search. The index management unit 54 executes management of the indexes (index management). The indexes are used to search the XML documents stored in the XML document storing area 421. The index management includes generation of the indexes, and storing of the generated indexes in the index storing area 422. The index management unit 54 comprises an index search unit 56 which searches the indexes stored in the index storing area 422. The index search unit 56 may be provided independently of the index management unit 54. The database operation unit 55 functions as an interface which allows the document management unit 52, the document search unit 53, and the index management unit 54 to access the XML database 42.

Next, (1) index setting process, (2) document storing process and (3) document search process, of the operations of the present embodiment, will be described in order.

(1) Index Setting Process

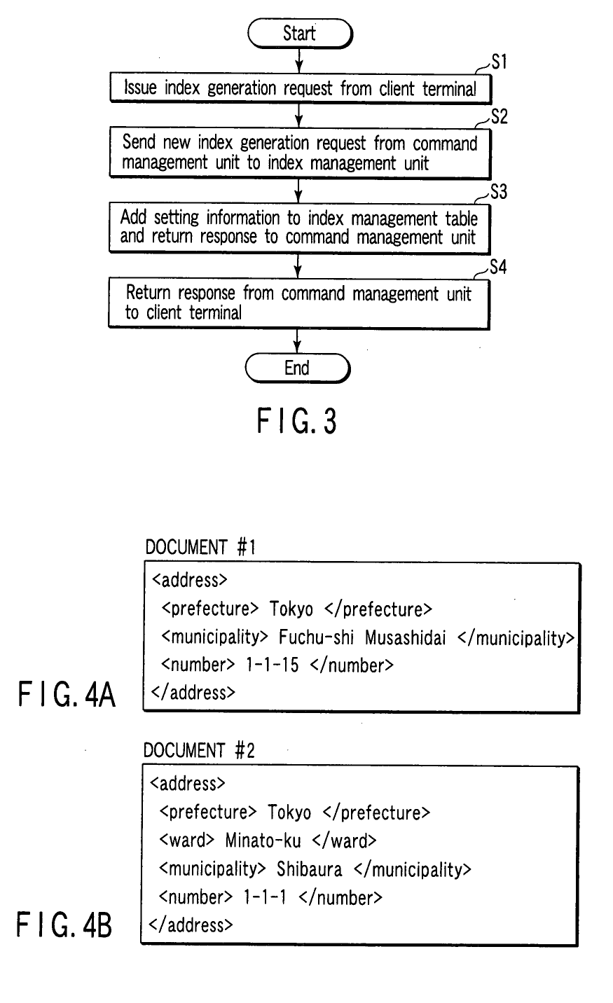

First, the index setting process will be described with reference to a flowchart of FIG. 3.

It is assumed that an application for using the structured document management system 50 by the client terminal 20 operates over the client terminal 20. In this state, search for a XML document including a plurality of text nodes in the structured document management system 50 is required for the user. The user operates the client terminal 20 to designate a node (tag) in which element nodes containing the values of a plurality of text node as the contents of the elements, respectively, depend on the designated node as lower nodes of the designated node. Then, the user operates the client terminal 20 to cause the client terminal 20 to issue an index generation request. The index generation request instructs concatenation of, for example, the values (texts) of all the text nodes depending on the designated node (designation node) and generation of index (character string concatenation index), over the XML document (hierarchy structure or tree structure of XML document). The text nodes depending on the designation node indicate text nodes capable of following from the designation node in a direction of the lower level (i.e. text nodes existing at a lower level than the designation node), over the hierarchy structure or the tree structure. The designation node indicates a node which becomes an origin of the index generation based on text concatenation and for which the generated index is set (assigned).

The client terminal 20 issues an index generation request (index generation command) including information about the designation node to the database server 10 via the network 30, on the basis of the above user operation (step S1). The index generation request is received by the command management unit 51 of the database server 10 (structured document management system 50). In the present embodiment, the designation node is represented by a path (structure information) from a route node over the hierarchy structure of the XML document to the designation node.

When the command management unit 51 receives the index generation request from the client terminal 20 (i.e. the index generation request from the outside as designated by the user), the command management unit 51 analyzes the request. On the basis of the analysis result of the request (command), the command management unit 51 selects the function unit to process the request, from the document management unit 52, the document search unit 53, and the index management unit 54. The command management unit 51 selects here the index management unit 54 as the function unit to process the index generation request, on the basis of the analysis result of the request. The command management unit 51 sends the index generation request from the client terminal 20 to the index management unit 54 (step S2).

On the basis of the index generation request sent from the command management unit 51, the index management unit 54 generates index setting information necessary for the new index generation and adds the index setting information to the ISMT 424 (step S3). The index setting information indicates information which is referred to when the index instructed by the index generation request is generated. Details of the information will be described later. In step S3, the index management unit 54 returns a response to the index generation request (for example, a notification of normal termination of the index generation) to the command management unit 51. If the copy of the ISMT 424 is stored in a memory (not shown) of the database server 10 and the addition and reference of the index setting information are executed over the copy, access to the ISMT 424 can be accelerated.

The command management unit 51 returns the response from the index management unit 54 to the client terminal 20 via the network 30 (step S4). In other words, the response to the index generation request is returned from the index management unit 54 to the client terminal 20, in the reverse route of the index generation request.

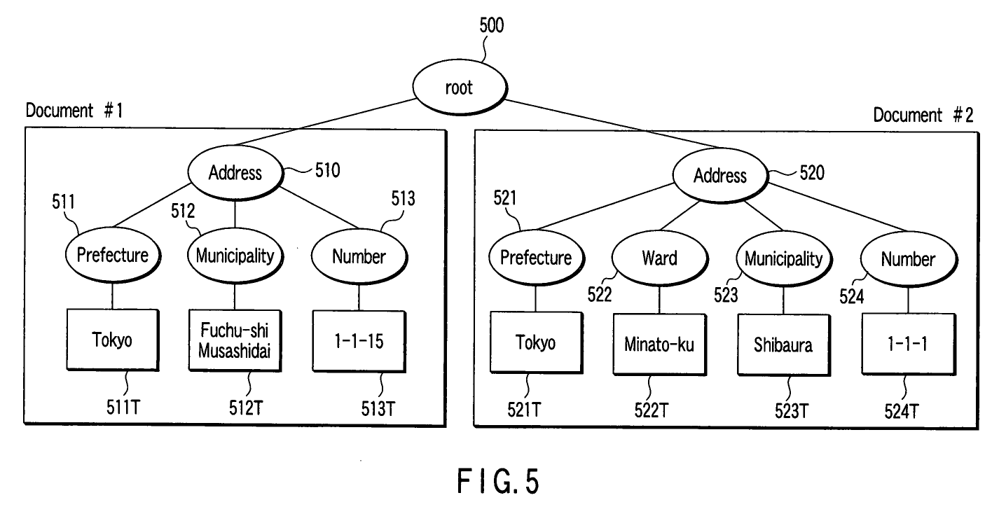

FIG. 4A and FIG. 4B show XML documents #1 and #2 that have already been stored or are to be newly stored in the XML document storing area 421, respectively. FIG. 5 shows the XML documents #1 and #2 shown respectively in FIG. 4A and FIG. 4B as expressed in tree structure. In FIG. 5, node 500 represented as “root” is a root node of the XML documents #1 and #2. Child nodes of the root node (i.e. nodes immediately under the root node) are element nodes 510 and 520 corresponding to elements including the <address> tags of the XML documents #1 and #2 (i.e. elements whose name is “address”). The element nodes 510 and 520 are also called address nodes 510 and 520. In FIG. 5, the root node and the element nodes are expressed in ellipsoid and text nodes are expressed in rectangle.

Child nodes of the node 510 are element nodes 511, 512 and 513 corresponding to the elements including the <prefecture> tag, the <municipality> tag and the <number> tag of the XML document #1, respectively. The element nodes 511, 512 and 513 are also called prefecture node 511, municipality node 512 and number node 513, respectively. Child nodes of the node 520 are element nodes 521, 522, 523 and 524 corresponding to the elements including the <prefecture> tag, the <ward> tag, the <municipality> tag and the <number> tag of the XML document #2, respectively. The element nodes 521, 522, 523 and 524 are also called prefecture node 521, ward node 522, municipality node 523 and number node 524, respectively.

Child nodes of the nodes 511, 512 and 513 are text nodes 511T, 512T and 513T corresponding to the texts “Tokyo”, “Fuchu-shi Musashidai” and “1-1-15”, respectively. The texts “Tokyo”, “Fuchu-shi Musashidai” and “1-1-15” are contents (values) of the elements including the <prefecture> tag, the <municipality> tag and the <number> tag, respectively. Child nodes of the nodes 521, 522 and 523 are text nodes 521T, 522T, 523T and 524T corresponding to the texts “Tokyo”, “Minato-ku”, “Shibaura” and “1-1-1”, respectively. The texts “Tokyo”, “Minato-ku”, “Shibaura” and “1-1-1” are contents of the elements including the <prefecture> tag, the <ward> tag, the <municipality> tag and the <number> tag, respectively.

In the present embodiment, the nodes designated by the index generation request (designation nodes) are the element nodes 510 and 520 corresponding to the elements including the <address> tags. The path from the root node to the element nodes 510 and 520 is expressed as “/address”. “/” included in the path “/address” indicates the root node in a case such as the above example where it is located at a leading part of the path. In the following descriptions, for example, “path from the root node to the node A” is expressed as “path to the node A” by omitting the path origin (root node).

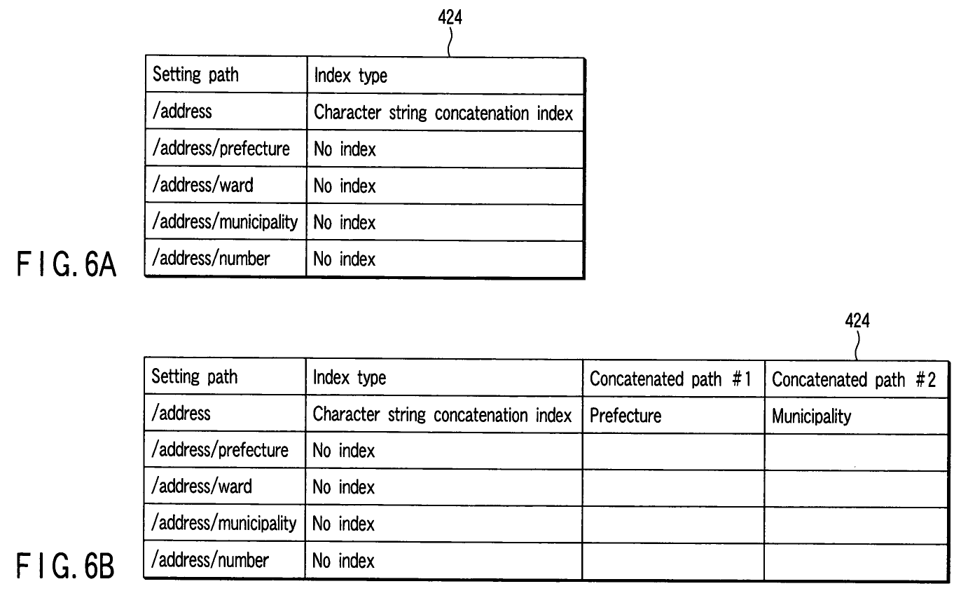

FIG. 6A shows an example of the ISMT 424 after adding the index setting information by the index management unit 54 in a case where the path to the designation node (node designated by the index generation request) is “/address”. Information (index setting information) of each entry of the ISMT 424 includes information about the setting path and the index type as shown in FIG. 6A. The index setting information including the path “/address” to the designation node as the setting path and including “character string concatenation index” as the index type is stored in the ISMT 424. In the present embodiment, the “character string concatenation index” indicates an index generated by concatenating in an appearance order the values (texts) of a plurality of text nodes depending on a designation node (tag). The designation node is a node designated by the path which is paired with the “character string concatenation index” in the index setting information. In the present embodiment, the index of the type indicated by the index setting information entered in the ISMT 424 (index type in the index setting information) is generated during storing of XML documents, as described below.

(2) Document Storing Process

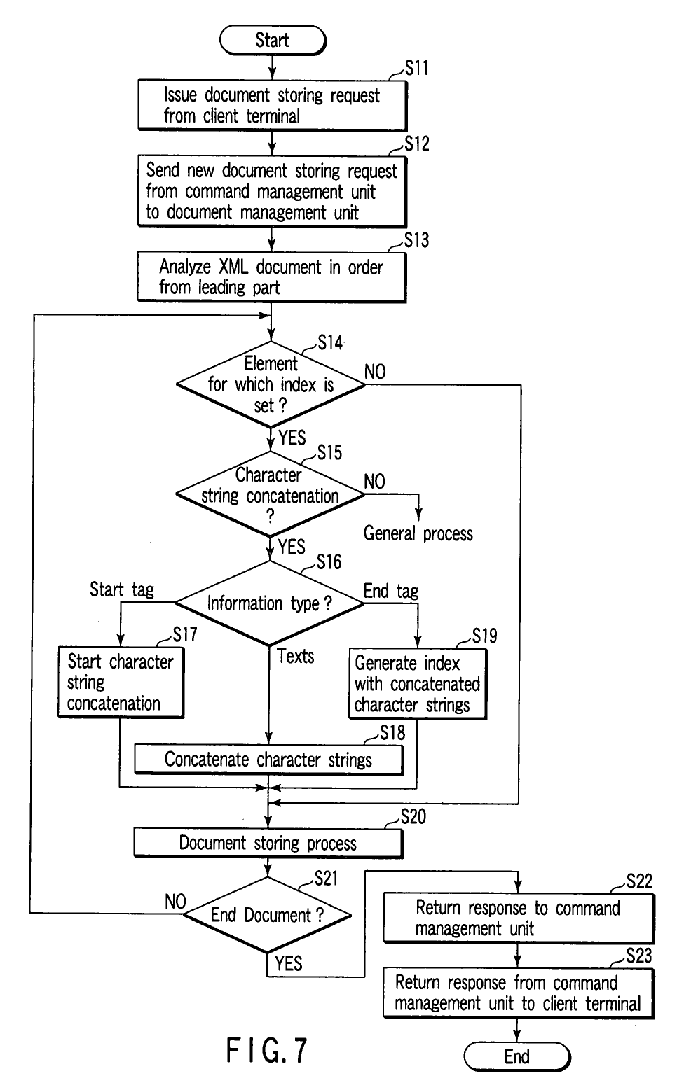

Next, the document storing process will be described with reference to a flowchart of FIG. 7. In accordance with the user operation of the client terminal 20, the terminal 20 issues a document storing request (document storing command) to instruct the XML document to be newly stored, to the database server 10 (step S11). The storing request is received by the command management unit 51 of the database server 10 (structured document management system 50).

When the command management unit 51 receives the document storing request from the client terminal 20, the command management unit 51 analyzes the request. On the basis of a result of the request (command) analysis, the command management unit 51 selects the document management unit 52 as a function unit to process the request. The command management unit 51 sends the document storing request of the client terminal 20 to the selected document management unit 52 (step S12).

In accordance with the document storing request sent from the command management unit 51, the document management unit 52 analyzes (parses) the XML document to be newly stored as designated by the request, in the order from a leading part of the XML document (step S13). At this time, the tag detection unit 52a in the document management unit 52 executes a process for detecting the element (element node) including the tag designated by the setting path in the index setting information entered in the ISMT 424.

The tag detection unit 52a first determines whether or not the analyzed information is the element designated by the setting path, i.e. the element (designation element) for which assignment (setting) of the index is designated (step S14). If the analyzed information is information (start tag, text or end tag) of the element (designation element) for which assignment of the index is designated (step S14), the tag detection unit 52a extracts the index type information, from the index setting information including the information of the path to the designation element, in the index setting information (step S15). In step S15, the tag detection unit 52a determines whether the extracted index type information indicates the “character string concatenation index”.

If the index type information does not indicate the “character string concatenation index” (step S15), the tag detection unit 52a causes the document management unit 52 to execute the general process for the analyzed information (i.e. the same process as the conventional process). On the other hand, if the index type information indicates the “character string concatenation index” (step S15), the tag detection unit 52a determines the type of the analyzed information (step S16). In other words, the tag detection unit 52a determines whether the analyzed information is the start tag (start tag of the designation element), text, or end tag (end tag of the designation element).

If the analyzed information is the start tag, i.e. if the tag detection unit 52a detects the start tag, the document management unit 52 starts the character string concatenation (step S17). If the analyzed information is the text, i.e. if the tag detection unit 52a newly detects the text, the document management unit 52 executes a process of concatenating the newly detected text (character string) with the text/texts (character string/character strings) which has/have already been detected in a character string concatenation area reserved on the memory of the database server 10, into a new character string (step S18). If the analyzed information is the end tag, i.e. if the tag detection unit 52a detects the end tag, the document management unit 52 activates the index management unit 54. Then, the index management unit 54 generates the index (character string concatenation index) composed of character strings concatenated in the character string concatenation area (step S19).

Thus, in the present embodiment, when the XML document including the node (tag) designated by the index generation request of the client terminal 20 is stored, the index (character string concatenation index) assigned to the designation node (path) of the XML document is generated on the basis of the index setting information including the information of the path to the designated node (designation node). Generation of the index on the basis of the index setting information is equivalent to generation of the index on the basis of the index generation request which is a trigger for the generation of the index setting information. However, generation of the index can be accelerated by applying the manner of generating the index on the basis of the index setting information as described in the present embodiment. If the index generation request from the client terminal 20 is prestored, the index generation request is analyzed at every storing of a new XML document and the index is generated on the basis of the analysis result, acceleration of the index generation is difficult, unlike the present embodiment.

As for the XML documents which have already been stored in the XML document storing area 421 (for example, the XML documents designated by the user and stored therein), an index for the designation node (path) of the documents may be generated. In other words, it is also possible to designate the XML document stored in the database server 10 (structured document management system 50), by the client terminal 20, in accordance with the user operation, and to generate an index to be assigned to the designation node (path) of the designated XML document.

If step S17, S18 or S19 is executed, the document management unit 52 executes step S20. The document management unit 52 also executes step S20 in a case where it is determined in step S14 that the analyzed information is not the information in the element for which the index generation is designated. In step S20, the document management unit 52 executes a document storing process of storing the analyzed information in the XML document storing area 421 of the XML database 42.

When the document management unit 52 executes step S20, the document management unit 52 determines whether storing of the XML document designated by the document storing request from the client terminal 20 has been ended (step S21). If the storing of the designated XML document has not been ended, the document management unit 52 returns to step S14. In step S14, the document management unit 52 determines whether the next analyzed information in the designated XML document is information in the element for which the index generation is designated.

After that, the document management unit 52 concatenates all the character strings (texts) appearing during a period after the start tag in the element for which the index generation is designated (detected) until the end tag in the element is designated (detected), in the order of appearance (step S18). If the end tag in the element for which the index generation is designated is determined (step S16), an index based on the character strings concatenated before the determination is generated by the index management unit 54 (step S19). In other words, the concatenated character strings are generated as the character string concatenation index (character string concatenation index data). In step S19, the index management unit 54 stores the generated character string concatenation index in the index storing area 422. The character string concatenation index is managed as the index assigned to the node (element node) designated by the index generation request. For example, B-tree or hash can be applied as the index form, but the other forms can also be employed. The process of concatenating the character strings (texts) (step S18) can also be executed by the index management unit 54.

When the process of storing the designated XML document is ended (step S21), the document management unit 52 returns the response to the document storing request (for example, notification of normal end of storing the document) to the command management unit 51 (step S22). The command management unit 51 returns the response from the document management unit 52 to the client terminal 20 via the network 30 (step S23). In other words, the response to the document storing request is returned from the document management unit 52 to the client terminal 20, in a reverse route to the document storing request.

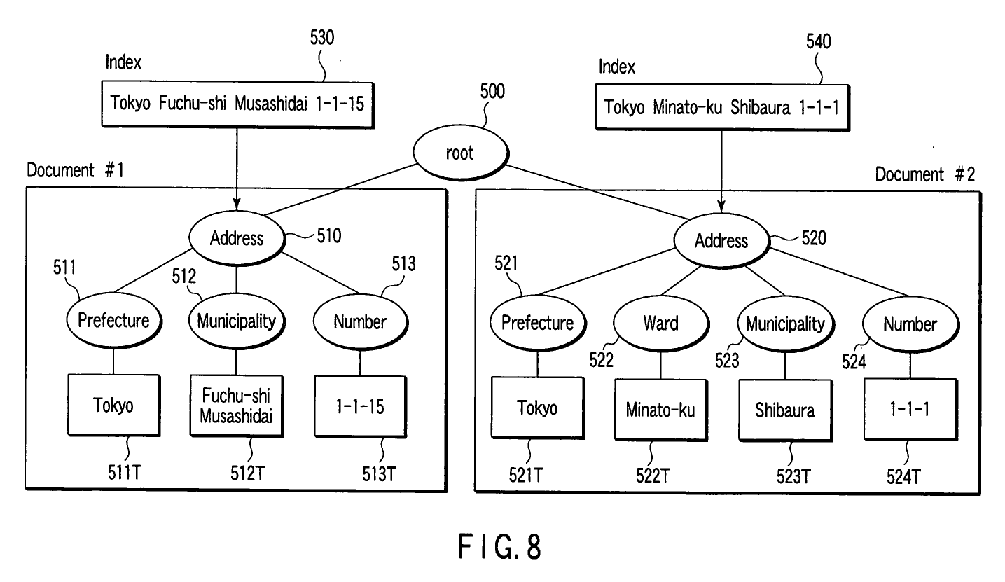

FIG. 8 shows indexes (character string concatenation indexes) assigned to path “/address” of the document #1 and document #2 (cf. FIG. 4A and FIG. 4B) represented in tree structure in FIG. 5, in association with the tree structure, on the basis of the index setting information to designate “path=/address” and “index type=character string concatenation” entered in the ISMT 424 of FIG. 6A. In FIG. 8, the element node whose element name is “address” as designated by the path “/address” of the document #1 is the address node (<address> tag) 510. Text nodes depending on the address node 510 are text nodes 511T, 512T and 513T. The values (texts) of the text nodes 511T, 512T and 513T are “Tokyo”, “Fuchu-shi Musashidai” and “1-1-15”. In this case, an index (character string concatenation index) 530 obtained by concatenating all the texts (character strings) is generated as an index (index data) assigned to the path “/address” (address node 510) of the document #1, as shown in FIG. 8. The index (index data) includes position information of the address node 510 to which the index is assigned, as described later.

Similarly, the element node whose element name is “address” as designated by the path “/address” of the document #2 is the address node (<address> tag) 520. Text nodes depending on the address node 520 are text nodes 521T, 522T, 523T and 524T. The values (texts) of the text nodes 521T, 522T, 523T and 524T are “Tokyo”, “Minato-ku”, “Shibaura” and “1-1-1”. In this case, an index (character string concatenation index) 540 obtained by concatenating all the texts (character strings) is generated as an index (index data) assigned to the path “/address” (address node 520) of the document #2, as shown in FIG. 8. The index (index data) includes position information of the address node 520 to which the index is assigned, as described later.

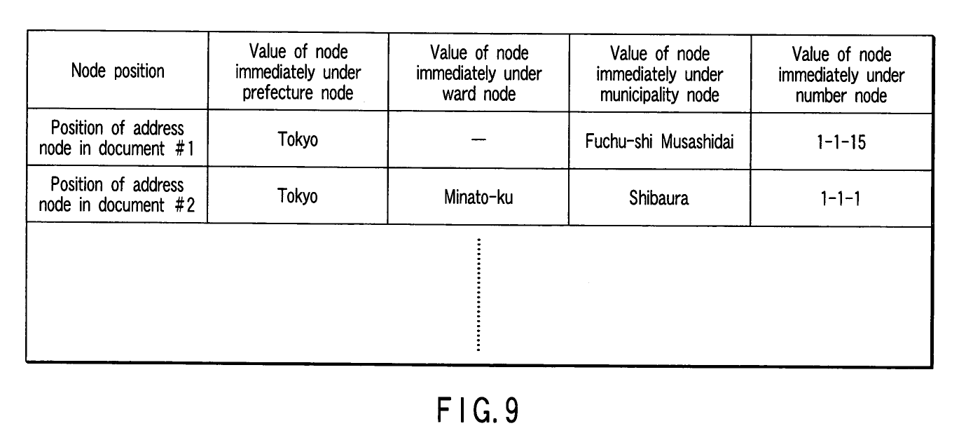

FIG. 9 shows an example of a data structure of the array (index data array) in the index storing area 422 of the generated character string concatenation index. Each of the indexes in the index data array shown in FIG. 9 contains the node position, the value (text) of the child node of the prefecture node (node immediately under the prefecture node), the value of the child node of the ward node, the value of the child node of the municipality node and the value of the child node of the number node.

The node position information indicates a node storing position in the corresponding XML document stored in the XML document storing area 421. More specifically, the node position information indicates a storing position of the node (tag) designated by the path in the index setting information entered in the ISMT 424, for example, a relative storing position in the XML document storing area 421.

The values (texts) of the nodes in the index are concatenated in the order of appearance in the corresponding XML document. In the present embodiment, the values of the nodes in the index are concatenated in the order of the child node of the prefecture node, the child node of the ward node, the child node of the municipality node, and the child node of the number node. In the document #1, however, the values of the nodes in the index are concatenated in the order of the child node of the prefecture node, the child node of the municipality node, and the child node of the number node as the child node of the ward node has no value.

(3) Document Search Process

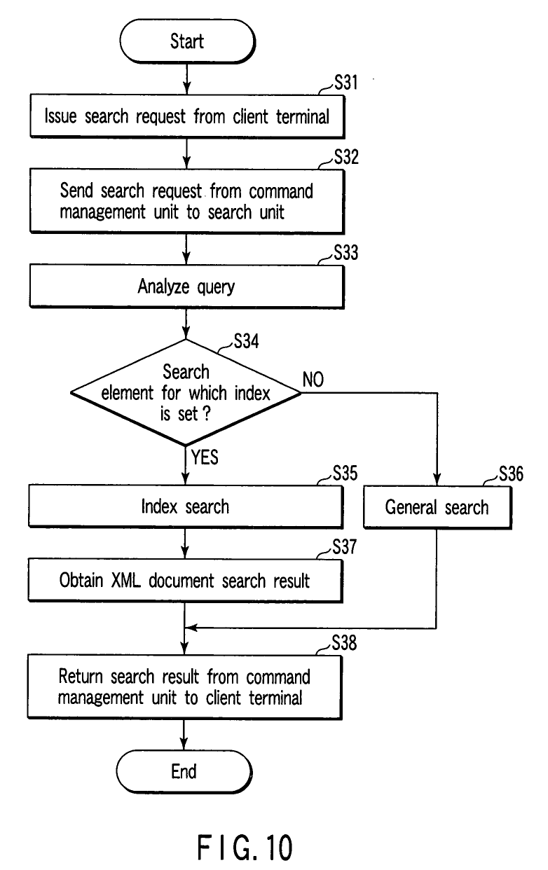

Next, the document search process will be described with reference to a flowchart of FIG. 10.

In accordance with the user operation of the client terminal 20, a search request to direct the database server 10 to search the XML document is currently issued from the terminal 20 (step S31). The search request contains search character strings (query, search conditions). In other words, the search request designates the search character string. The search request is received by the command management unit 51 of the database server 10 (structured document management system 50).

When the command management unit 51 receives the search request from the client terminal 20, the command management unit 51 analyzes the request. On the basis of a result of analysis of the request, the command management unit 51 selects the document search unit 53 as a function unit to process the request. The command management unit 51 sends the search request from the client terminal 20 to the selected document search unit 53 (step S32).

The document search unit 53 analyzes the search character string (query, search condition) indicated by the search request sent from the command management unit 51 (step S33). On the basis of a result of analysis of the search character string, the document search unit 53 determines whether search of the data indicated by the search character string is the search using the values of the text nodes depending on the element node (tag) to which the character string concatenation index is assigned (step S34). If it is determined that the search request meets this condition, the document search unit 53 requests the index search unit 56 in the index management unit 54 to search the index (character string concatenation index) assigned to the corresponding element node. Then, the index search unit 56 searches the requested character string concatenation index in the index storing area 422 (step S35). If the search request does not meet the condition, the document search unit 53 executes the general search process (step S36).

When the document search unit 53 requests the index search unit 56 to search the character string concatenation index, a result of the search is returned from the index search unit 56 to the document search unit 53. When the document search unit 53 obtains the search result of the character string concatenation index from the index search unit 56, the operation shifts to step S37. In step S37, the document search unit 53 searches the XML document including the tag to which the character string concatenation index is assigned, by using the searched (obtained) character string concatenation index, and obtains a result of the search (XML document search result). On the basis of the node position information included in the character string concatenation index, the XML document including the node (tag) represented by the node position information is searched in the XML document storing area 421. The command management unit 51 receives the XML document search result obtained by the document search unit 53 and returns the search result to the client terminal 20 (step S38).

According to the manner of generating the character string concatenation index applied to the present embodiment, it is obvious from a principle of the generation that the process corresponding to the AND merge process is equivalent to the process which has already been executed at the generation of the character string concatenation index. The AND merge process is a process for confirming, when the index generated in units of element node at the terminal of an XML document in the prior art as described above, whether results hit with an index assigned to the element node of the terminal are included in the same document. When that the process corresponding to the AND merge process has already been executed at the generation of the character string concatenation index, the AND merge process is not required by searching the XML document with the character string concatenation index searched by the index search unit 56 as executed in the present embodiment. For this reason, the search using as a condition the values of the text nodes depending on the element node (tag) to which the character string concatenation index has been assigned, can be accelerated by using the character string concatenation index, and deterioration of the performance can be prevented even in a case of a number of hit counts.

A concrete example of the XML document search using the character string concatenation index will be described. As the query represented by the search request, “/address[contains(., “Tokyo Minato-ku Shibaura”)]” is used. In this case, in the example of the index data array of FIG. 9, character string concatenation index “Tokyo Minato-ku Shibaura 1-1-1” including “Tokyo Minato-ku Shibaura”, and the position of the address node (address tag) of the document #2 (i.e. position in the XML document storing area 421) are obtained by the index search unit 56.

The character string concatenation index “Tokyo Minato-ku Shibaura 1-1-1” is generated by concatenating the values (texts) of all the text nodes 521-524 depending on the address node 520 of the document #2 in the order of their appearance. Therefore, the position of the address node (address tag) of the document #2 specifies the address node (address tag) of the XML document (document #2) “address contains “Tokyo Minato-ku Shibaura””. The document search unit 53 can search the XML document (document #2) “address contains “Tokyo Minato-ku Shibaura”” from the position of the address node.

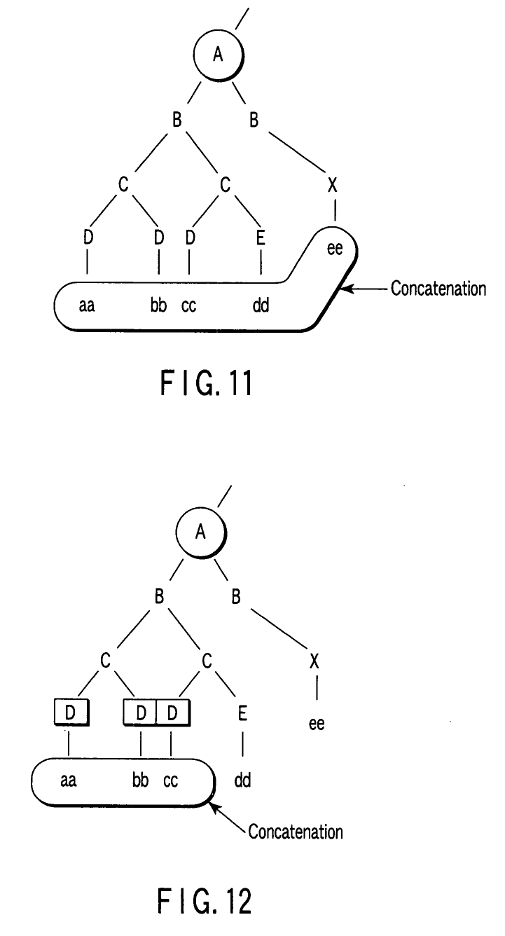

As described above, by concatenating the values (texts) of all the text nodes depending on the designation node in the XML document, the index (character string concatenation index) assigned to the designation node is generated. FIG. 11 shows a model of the index generation. In FIG. 11, A, B, C, D, E and X represent element nodes (tags) in a case where an XML document is represented in the tree structure, and character strings “aa”, “bb”, “cc”, “dd” and “ee” represent the values of the elements (text nodes) of element nodes D, D, D, E, and X. The element node A in a circle is a node (designation node) to which the character string concatenation index is assigned. In the example of FIG. 11, the character string concatenation index assigned to the element node A (character string concatenation index of element node A) is generated by concatenating all the texts (character strings) “aa”, “bb”, “cc”, “dd” and “ee” depending on the node A.

### FIRST MODIFIED EXAMPLE

A first modified example of the above embodiment will be described. In the embodiment, all the text nodes (values) depending on the designation node (tag) are concatenated. However, when some of the text nodes are used as the search condition, the text nodes can be indexed. In this case, as a volume of the index can be reduced, the storing area of the external storage device 40 occupied by the index storing area 422 is decreased and the acceleration of the search can be expected. Thus, the characteristic of the first modified example is to concatenate some of the text nodes depending on the designation node and generate an index of the text nodes.

FIG. 12 shows a model of the index generation applied to the first modified example. FIG. 12 shows the same tree structure as that of FIG. 11. In the example of FIG. 12, the index (character string concatenation index) of the element node (tag) A is generated by concatenating the character strings “aa”, “bb” and “cc”, which are the values of the elements (text nodes) of three element nodes D, D, and D in rectangle, of the element nodes D, D, D, E and X.

In the first modified example, the different index generation request from that applied to the above embodiment is sent from the client terminal 20 to the structured document management system 50, for the generation of the character string concatenation index. Besides the path (setting path) to the element node A representing the designation node (tag), the index generation request applied to the first modified example designates text nodes to be indexed (concatenated), of all the text nodes depending on the designation node (tag). Text nodes to be index are designated, from the designation nodes, by a relative path (concatenated path) to parent nodes of the text nodes to be index.

In the example of FIG. 12, the path to the element node A is designated as the setting path and the relative path “B/C/D” from the element node A is designated as the concatenated path, in response to the index generation request. When the index management unit 54 receives the index generation request, the index management unit 54 determines that the text nodes immediately under three nodes D, D, and D represented by the relative path “B/C/D” from the node A (by one level), of all the text nodes depending on the node A, are designated as the text nodes to be indexed (concatenated). The index management unit 54 enters the index setting information responding to the index generation request in the ISMT 424 (step S3 of FIG. 3).

In the first modified example, a maximum of two paths to be concatenated can be designated. Thus, the index setting information entered in the ISMT 424 in the first modified example includes the information of two concatenated paths #1 and #2, besides the information of the setting path and the index type shown in FIG. 6. In the above example in which “B/C/D” is designated as the concatenated path, the path to the designation node A and “character string concatenation index” are used respectively as the setting path and the index type included in the index setting information. In addition, for example, “B/C/D” is used as the concatenated path #1.

If the index type included in the index setting information is the character string concatenation index, the document management unit 52 can concatenate the values (texts) of the text nodes immediately under the nodes represented by the concatenated path #1 (i.e. relative path “B/C/D” from the node A), all the text nodes depending on the node A designated by the setting path included in the index setting information. As for the order of concatenation in the first modified example, the text nodes immediately under the nodes represented by the concatenated path #1 have priority and the text nodes immediately under the nodes represented by the concatenated path #1 have second priority. If a plurality of nodes are represented by a single concatenated path #i (i=1, 2), the order of concatenating the text nodes immediately under the nodes is the order of their appearance.

Next, it is assumed that, by the index generation request, the text nodes immediately under the element nodes E are designated as the text nodes to be indexed, besides the text nodes immediately under the element nodes D. In this case, the index setting information including the path to the designated node A as the setting path, “character string concatenation index” as the index type, “B/C/D” as the concatenated path #1, and “B/C/E” as the concatenated path #2 is entered in the ISMT 424 by the index management unit 54. If the index type included in the index setting information is the character string concatenation index, the document management unit 52 can concatenate the text nodes immediately under the nodes represented by the concatenated path #1 (i.e. relative path “B/C/D” from the node A) and the text nodes immediately under the nodes represented by the concatenated path #2 (i.e. relative path “B/C/E” from the node A).

If indexing all the text nodes depending on the node A is designated by the index generation request as described in the above embodiment, the index management unit 54 sets nothing as the concatenated paths #1 and #2 of the index setting information. In this case, as the concatenated paths #1 and #2 of the index setting information are not designated, the document management unit 52 concatenates all the text nodes (values of the text nodes) depending on the node A designated by the setting path, similarly to the above embodiment.

FIG. 6B shows an example of the ISMT 424 applied to the first modified example. The information (index setting information) of each entry in the ISMT 424 shown in FIG. 6B includes information on the concatenated paths #1 and #2, besides the information of the setting path and the index type. In FIG. 6B, in the index setting information in which “/address” and “character string concatenation index” are set as the setting path and the index type, respectively, the relative paths “prefecture” and “municipality” from the address node are set as the concatenated paths #1 and #2, respectively. At the time of storing the XML document, for example, the document management unit 52 concatenates the values of the prefecture node and the municipality node designated by the respective relative paths “prefecture” and “municipality” from the address node set in the index setting information as the concatenated paths #1 and #2, of all the text nodes depending on the address node designated by the setting path “/address”, on the basis of the index setting information. Thus, the value of the text node (i.e. text) immediately under the prefecture node and the value of the text node (i.e. text) immediately under the municipality node are concatenated.

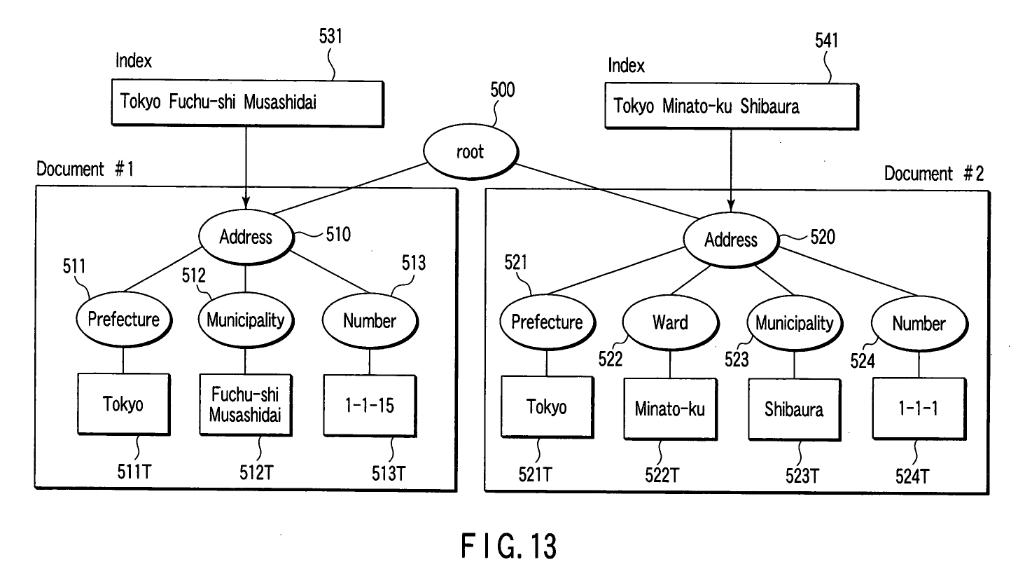

FIG. 13 shows the indexes (character string concatenation indexes) assigned to the path “/address” on the basis of the above index setting information entered in the ISMT 424 of FIG. 6B at the time of storing the documents #1 and #2 represented in tree structure in FIG. 5, in association with the tree structure. In this example, as for the document #1, index 531 is generated by concatenating the value “Tokyo” of the prefecture node 511 and the value “Fuchu-shi Musashidai” of the municipality node 512, of the values of all the texts depending on the “address” node 510, as an index assigned to the “address” node 510. Similarly, as for the document #2, index 541 is generated by concatenating the value “Tokyo” of the prefecture node 521 and the value “Shibaura” of the municipality node 523, of the values of all the texts depending on the “address” node 520, as an index assigned to the “address” node 520. The number of concatenated paths included in the index setting information is not limited to two. If N represents an arbitral integer of 1 or more, the number of concatenated paths may be N.

### SECOND MODIFIED EXAMPLE

Next, a second modified example of the embodiment will be described. A characteristic of the second modified example is that in a case where an order of priorities (order of concatenation) of text nodes to be indexed is designated by the index generation request of the client terminal 20, the text nodes to be indexed are ordered and managed in the designated order of priorities.

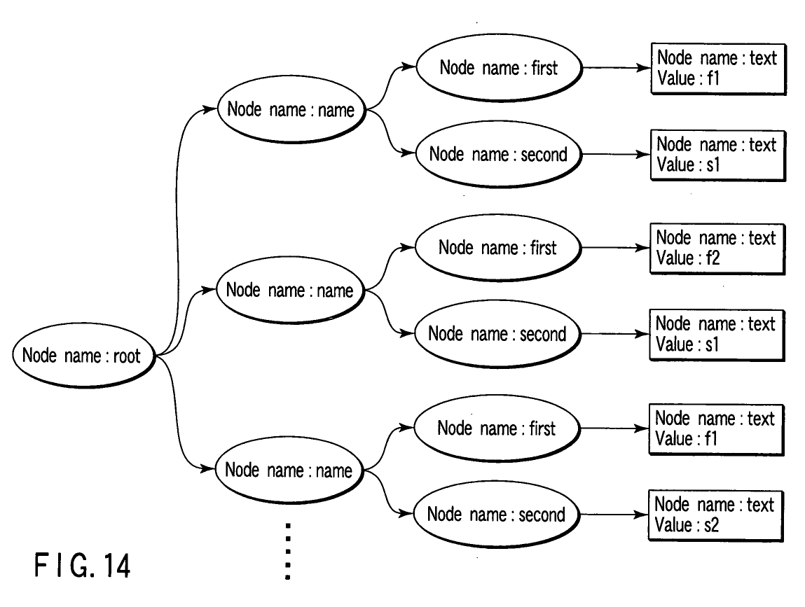

FIG. 14 shows an example of the XML document represented in the tree structure. Each of ellipsoids or rectangles represents a node. Each node represented by the ellipsoid is assigned a name. A character string such as “root” written in the ellipsoid indicates a node name. On the other hand, each of terminal nodes represented by rectangles in FIG. 14 is a text node having the value (for example, “f1”) of the element of the parent node (element node), which has the common node name “text”. In the example of the XML document shown in FIG. 14, a pair of “first” node and “second” node exists immediately under each node having the node name “name”, i.e. each “name” node.

In the second modified example, it is assumed that the index setting information including the path (/name) to the “name” node as the setting path and including information indicating the character string concatenation index as the index type is entered in the ISMT 424. The index setting information includes relative paths from the “name” node, “first” and “second” as the concatenated paths #1 and #2. In the second modified example, the value of the “text” node immediately under each “first” node designated by the concatenated path #1 has higher priority than the value of the “text” node immediately under each “second” node designated by the concatenated path #2, in an array of generated character string concatenation indexes (index data array). The indexes are thereby sorted on the basis of the values of the “text” nodes immediately under the “first” nodes included in the indexes, in the index data array. For this reason, the index setting information entered in the ISMT 424 includes information indicating that the value of the “text” node immediately under each “first” node designated by the concatenated path #1 has priority in the index data array.

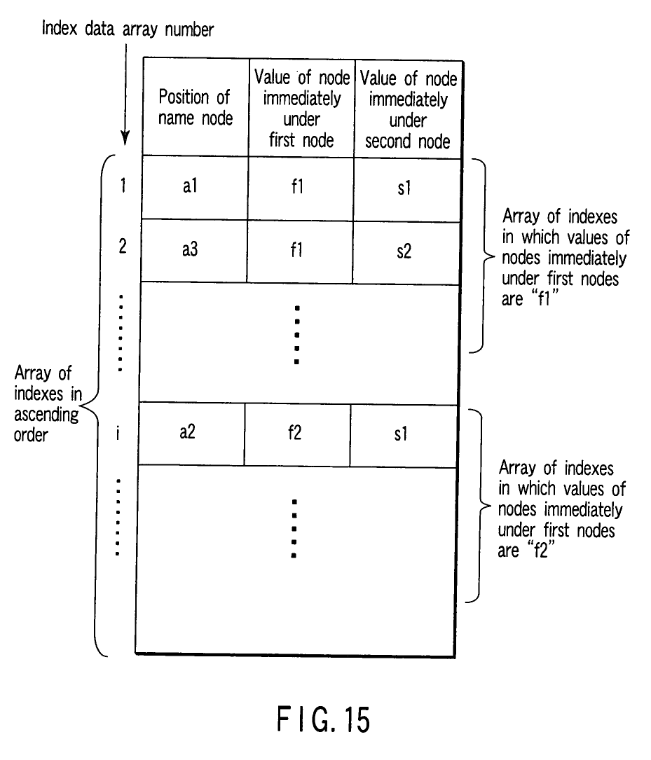

FIG. 15 shows an example of a data structure in the index data array stored in the index storing area 422, by the generation of the character string concatenation index based on the above index setting information at the time of storing the XML document having the tree structure shown in FIG. 14. The indexes in the index data array in FIG. 15 include the position information of the “name” node, and the values of the “text” nodes immediately under both the “first” node and the “second” node paired immediately under the “name” node. The indexes are sorted, for example, in the ascending order, on the basis of the values of the “text” nodes immediately under the “first” nodes having higher priority orders than the “second” nodes. In addition, the indexes in which the values of the “text” nodes immediately under the “first” nodes are equal are further sorted on the basis of the values of the “text” nodes immediately under the “second” nodes.

For this reason, in the index data array shown in FIG. 15, the indexes including the value “f1” of the “text” nodes immediately under the “first” nodes are arranged in an area in which an array number in the index data array (index data array number) is small. The indexes including the value “f2” (f2>f1) of the “text” nodes immediately under the “first” nodes are arranged in an area in which the array number in the index data array is great. On the other hand, the indexes including the value “s1” of the “text” nodes immediately under the “second” nodes and the indexes including the value “s2” of the “text” nodes immediately under the “second” nodes, may be dispersed in the index data array.

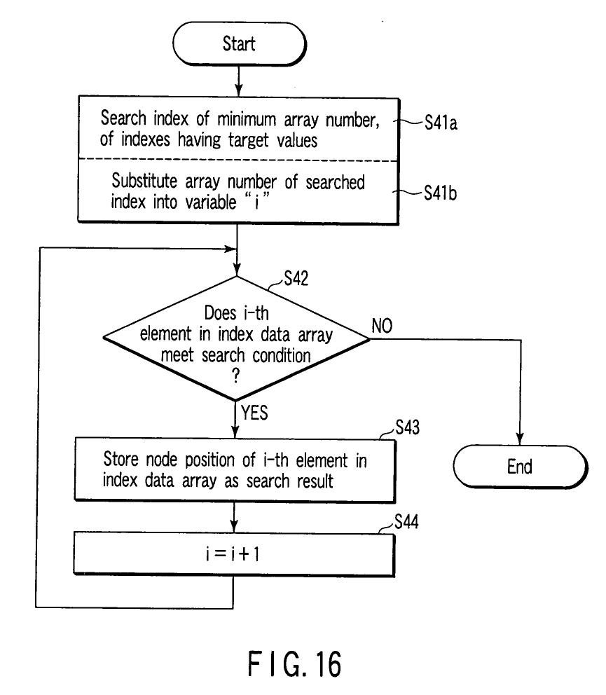

Next, steps of an index search process of the indexes (index data array) shown in FIG. 15 (i.e. an index search process corresponding to step S35 of FIG. 10) will be described with reference to a flowchart of FIG. 16. First, the index search unit 56 searches an index whose array number (index data array number) is stored in a minimum position, of indexes in the index data array having a target value designated by the query represented by the search request from the client terminal 20 (step S41a). Next, the index search unit 56 substitutes an array number of the searched index into variable “i” (step S41b). The index search unit 56 determines whether an i-th element (index) in the index data array meets a search condition designated by the query (step S42).

If the i-th element (index) in the index data array meets the search condition, the index search unit 56 stores the node position information included in the i-th index, as a search result, in the memory of the database server 10 (step S43). The index search unit 56 increments the variable “i” by 1 and designates a position of a next (neighboring) index (index data array number) in the index data array (step S44). The index search unit 56 determines whether the index in the index data array designated by the incremented variable “i” meets the search condition (step S42).

In the second modified example, as for the index data array, the “first” nodes, of the “first” nodes and “second” nodes paired immediately under the “name” nodes have priorities. In other words, in the index data array, the indexes at the values of the “text” nodes immediately under the “first” nodes are sorted in the ascending order. For this reason, the indexes having the same values of the nodes immediately under the “first” nodes are adjacent in the index data array. Thus, the search process can be accelerated under a specific search condition such as “values of the nodes immediately under the “first” nodes match “f1”” or “values of the nodes immediately under the “first” nodes are not smaller than “f1” and not greater than “f2””. In an example of such a search process, if it is determined that the i-th index in the index data array does not meet the search condition (step S42), the index search unit 56 can determine that there is no index satisfying the search condition. In this case, the index search unit 56 can immediately end the index search process. In other words, it is possible to prevent unnecessary index search from being repeated in the second modified example.

On the other hand, it is difficult to accelerate the search process under a search condition of, for example, “matching the character string having the value of the nodes immediately under the “second” nodes” in relation to the nodes having lower priorities in the index data array. The reason is that as the index hits may be dispersed in the index data array, the search range becomes broad. To accelerate such a search, new indexes may be set by causing the “second” nodes to have higher priorities than the “first” nodes.

### THIRD MODIFIED EXAMPLE

Next, a third modified example of the embodiment will be described. There are some XML documents wherein the value type cannot be specified from the only node structure. If the value type is specified as the search condition, it is difficult to accelerate the search of such XML documents. A characteristic of the third modified example is that when the index is generated in response to the index generation request from the client terminal 20, the value of the node is converted into a type designated by the request.

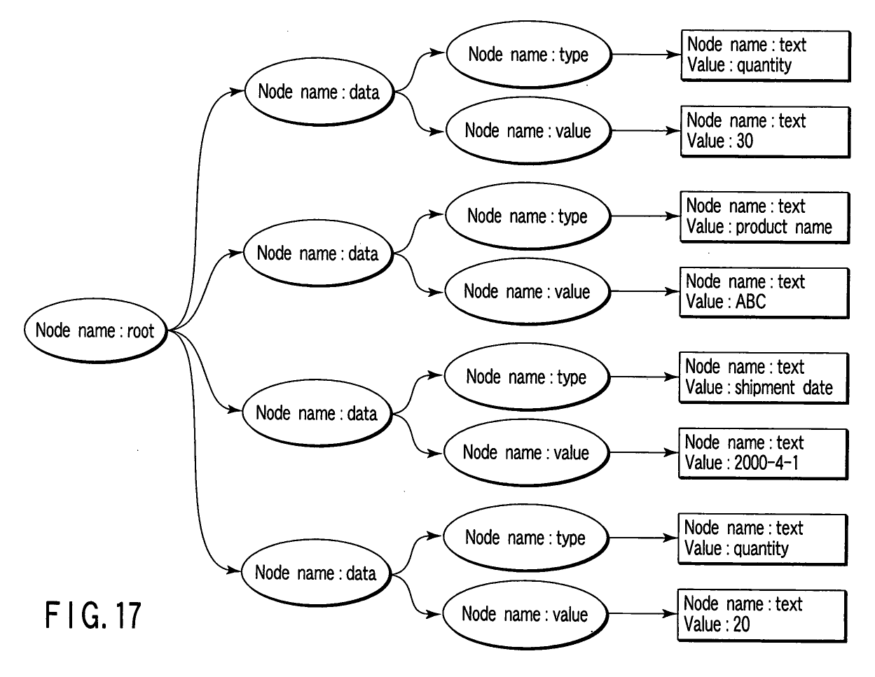

FIG. 17 shows a tree structure of an XML document wherein the value type cannot be specified on the basis of the only node structure. In the XML document of FIG. 17, there is a pair of “type” node and “value” node immediately under each of the “data” nodes. A “text” node immediately under each of the “type” nodes has a value representing the kind such as “quantity”, “product name” or “shipment date”.

On the other hand, a “text” node immediately under the “value” node paired with the “type” node has a value corresponding to the value of the “type” node. For example, if the value of the “text” node immediately under the “type” node is “quantity”, the value of the “text” node immediately under the “value” node paired with the “type” node is an integer. If the value of the “text” node immediately under the “type” node is “product name”, the value of the “text” node immediately under the corresponding “value” node is a character string. Similarly, if the value of the “text” node immediately under the “type” node is “shipment date”, the value of the “text” node immediately under the corresponding “value” node is a date.

A characteristic of the XML document shown in FIG. 17 is that the value type cannot be specified from the only node structure. In other words, it cannot be determined whether the value of the “text” node is, for example, the integer, character string or date, from the only information representing the structure of the “text” node immediately under the “value” node designated by the path “/data/value”. In the third modified example, the type for index is designated by the index generation request and information to designate the type (type designation information) is included in the index setting information. The index setting information including the type designation information is generated by the index management unit 54 in accordance with the index generation request and entered in the ISMT 424. When the index is generated on the basis of the index setting information, the value of the “text” node to be index is converted into the value of the type designated by the type designation information by the index management unit 54.

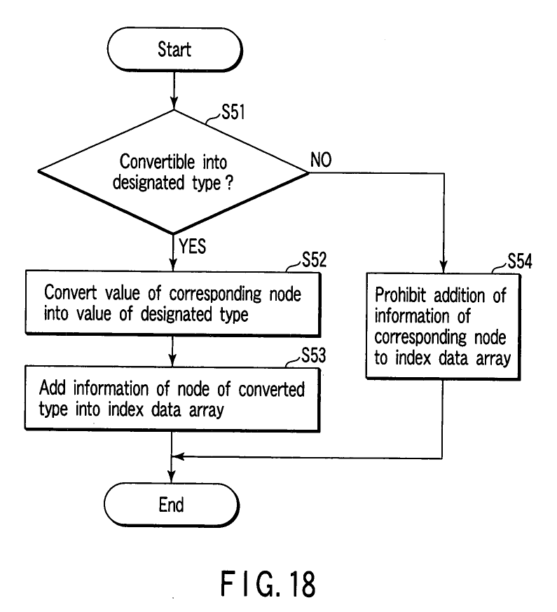

The type converting process of the index management unit 54 at the index generation will be described with reference to a flowchart of FIG. 18. In response to the index generation request from the client terminal 20, “/data” is designated as the setting path, “type” and “value” are designated as the concatenated paths #1 and #2, respectively, and an integer is designated as the type of the “text” node immediately under the “value” node.

It is assumed that the information (value) of the “text” node immediately under the “value” node designated by the concatenated path #2 is detected in the XML document shown in FIG. 17. Of the integer, character string and date, the integer is designated as the value type of the “text” node immediately under the “value” node. The value type is not limited to these three types but, for example, a floating point can also be applied to the value type.

In a case where the integer is designated as the value type of the “text” node immediately under the “value” node, the index management unit 54 determines whether the value of the “text” node immediately under the “value” node detected by the document management unit 52 can be converted into the designated type (i.e. integer) (step S51). If the value of the “type” node paired with the “value” node is “quantity”, the value of the “text” node immediately under the “value” node is the character string representing an integer. In such a case, the index management unit 54 determines that the detected value of the “text” node immediately under the “value” node can be converted into the designated type (i.e. integer) (step S51).

Next, the index management unit 54 converts the detected value of the “text” node immediately under the “value” node into the value of the designated type (step S52). In this example, the character string representing the integer is converted into the integer. The index management unit 54 adds the type-converted information (value) of the “text” node to the index data array (step S53).

On the other hand, if the detected value of the “text” node immediately under the “value” node is the product name or the character string representing the date, the index management unit 54 determines that the value of the “text” node cannot be converted into the designated type, i.e. integer (step S51). In this case, the index management unit 54 restricts addition of the detected information of the “text” node immediately under the “value” node to the index data array (step S54).

Thus, the only indexes having the values of the “text” nodes immediately under the “value” nodes as numerical values (integers) are set in the index data array. If the “value” nodes have higher priorities than the “type” nodes, the indexes are sorted in the index data array on the basis of the relationship in magnitude of the numerical values of the “text” nodes immediately under the “value” nodes. In other words, the indexes are sorted in the index data array, in a different order from an order of appearance of corresponding character strings, for example, in a dictionary. In addition, in the indexes, the values of the “text” nodes immediately under the “value” nodes are stored not as the character strings, but as numerical values (integers). In other words, the data storing method in the indexes can be optimized by using the type information of the “text” nodes. For this reason, the data amount of the indexes is reduced as compared with that in a case where the values of the “text” nodes immediately under the “value” nodes are character strings, and the overall data amount of the indexes can be reduced.

It is assumed that with the indexes thus sorted, search is executed under the condition, for example, “the value of the “text” node immediately under the “type” node is “quantity” and the value of the “text” node immediately under the “value” node is not smaller than 20 and not greater than 25”. As described above, the indexes are sorted on the basis of the relationship in magnitude of the numerical values of the “text” nodes immediately under the “value” nodes. For this reason, the hit indexes are proximate in the index data array and the search process can be therefore accelerated.

Thus, on the basis of the type designated for the index generation, the index management unit 54 converts the type of the only node information that can be converted into the designated type and stores the converted type in the index data array. The data amount of the indexes can be thereby reduced and the search speed can be enhanced. Moreover, the search speed can be enhanced even in the search of the XML document wherein the type of the node value cannot be specified from the only node structure information.

In the embodiment and the modified examples thereof, it is assumed that the structured document is the XML document. However, the present invention can also be applied to a structured document such as a SGML (Standard Generalized Markup Language) document other than the XML document. In addition, the client terminal 20 is connected to the database server 10 of the structured document management system 50 via the network 30. However, the client terminal 20 may be connected directly to the database server 10 of the structured document management system 50. Moreover, the keyboard, display unit and the like of the database server 10 can be employed similarly to the client terminal 20, by operating the applications over the client terminal 20 in the same manner of the operation over the client terminal 20. In other words, the database server 10 may be employed as the client terminal.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A structured document management system, comprising:
a structured document database including a structured document storing area in which a plurality of structured documents are stored and an index storing area in which indexes are stored, the indexes being used to search the structured documents stored in the structured document storing area;
a tag detection unit configured to detect, in accordance with an index generation request which is sent from an outside of the structured document management system to direct generation of a character string concatenation index and which designates a tag assigned the generated character string concatenation index, the tag designated by the index generation request, from a structured document which is newly stored or has already been stored in the structured document storing area; and
an index management unit configured to generate a character string concatenation index assigned to the tag detected by the tag detection unit and store the generated character string concatenation index in the index storing area, the generated character string concatenation index including values of a plurality of text nodes concatenated, the plurality of text nodes being included in the structured documents having the detected tag and depending on the detected tag.

2. The structured document management system according to claim 1, further comprising:
an index search unit configured to search a character string concatenation index meeting a search condition indicated by a search request sent from the outside of the structured document management system; and
a document search unit configured to search a structured document including the tag to which the character string concatenation index is assigned, by using the character string concatenation index searched by the index search unit.

3. The structured document management system according to claim 1, wherein the index management unit generates the character string concatenation index by using all of text nodes depending on the tag designated by the index generation request as the plurality of text nodes.

4. The structured document management system according to claim 3, further comprising an index setting management table employed to enter index setting information, the index setting information including a pair of path information and index type information, the path information indicating a path to the tag designated by the index generation request, the index type information indicating a type of an index to be generated,
wherein
if the index generation request directs the generation of the character string concatenation index, the index management unit generates the index setting information including the pair of the path information and the index type information indicating a character string concatenation index and enters the generated index setting information in the index setting management table;
the tag detection unit detects, as the tag designated by the index generation request, a tag indicated by the path information included in the index setting information entered in the index setting management table, in the structured document which is newly stored or has already been stored in the structured document storing area; and
the index management unit generates the character string concatenation index assigned to the detected tag if the index type information included in the index setting information paired with the path information indicating the path to the detected tag indicates the character string concatenation index.

5. The structured document management system according to claim 1, wherein if the index generation request includes information to designate text nodes to be indexed, of all of text nodes depending on the tag designated by the request, the index management unit generates the character string concatenation index by using the text nodes designated by the information as the plurality of text nodes.

6. The structured document management system according to claim 5, further comprising an index setting management table employed to enter index setting information, the index setting information including a group of first path information, index type information and second path information, the first path information indicating a path to the tag designated by the index generation request, the index type information indicating a type of the index to be generated, the second path information indicating information to designate the text nodes to be indexed,
wherein
if the index generation request directs the generation of the character string concatenation index and includes the information to designate the text nodes to be indexed, the index management unit generates the index setting information including the group of the first path information, the index type information indicating a character string concatenation index and the second path information, and enters the generated index setting information in the index setting management table;
the tag detection unit detects, as the tag designated by the index generation request, a tag indicated by the first path information included in the index setting information entered in the index setting management table, in the structured document which is newly stored or has already been stored in the structured document storing area; and
if the index type information included in the index setting information of a same group as the first path information indicating the path to the detected tag indicates the character string concatenation index, the index management unit generates the character string concatenation index by using the text nodes designated by the second path information that is in the same group as the first path information and that is included in the index setting information as the plurality of text nodes.

7. The structured document management system according to claim 5, wherein if the index generation request includes information designating priorities of the plurality of text nodes to be index, the index management unit sorts character string concatenation indexes that are generated for respective structured documents and that are stored in the index storing area, in accordance with values of the text nodes having higher priorities in the index storing area.

8. The structured document management system according to claim 5, wherein if the index generation request includes information designating types of the values of the text nodes to be indexed, the index management unit converts the values of the text nodes to be indexed into values of the designated types and adds the converted values of the text nodes to the index storing area.

9. The structured document management system according to claim 8, wherein if character strings indicating the values of the text nodes to be indexed are convertible into the values of the designated types, the index management unit executes the conversion into the values of the designated types.

10. The structured document management system according to claim 9, wherein if other text nodes that are paired with the text nodes to be indexed and that have the values indicating the types of the values of the text nodes to be indexed are present, the index management unit determines whether the character strings are convertible into the values of the designated types, in accordance with the types of the values of the text nodes to be indexed as indicated by the values of the other text nodes.

11. A method for managing indexes in a structured document management system, the structured document management system including a structured document database, the structured document database including a structured document storing area employed to store a plurality of structured documents and an index storing area employed to store the indexes, the indexes being employed to search the structured documents stored in the structured document storing area, the method comprising:
accepting an index generation request which is sent from an outside of the structured document management system to direct generation of a character string concatenation index and which designates a tag assigned the generated character string concatenation index;
detecting, in accordance with the index generation request, the tag designated by the index generation request, from a structured document which is newly stored or has already been stored in the structured document storing area;
concatenating values of a plurality of text nodes depending on the detected tag included in the structured document having the detected tag; and
storing in the index storing area the character string concatenation index that includes the values of the plurality of text nodes concatenated and that is assigned to the detected tag.

12. The method according to claim 11, further comprising:
searching a character string concatenation index meeting a search condition indicated by a search request sent from the outside of the structured document management system; and
searching a structured document including the tag to which the character string concatenation index is assigned, by using the searched character string concatenation index.

13. The method according to claim 11, wherein the values of the plurality of text nodes concatenated are values of all of text nodes depending on the detected tag included in the structured document having the detected tag.

14. The method according to claim 11, wherein if the index generation request includes information to designate text nodes to be indexed, of all of text nodes depending on the tag designated by the request, values of the text nodes designated by the designation information are concatenated as the values of the plurality of text nodes.

15. The method according to claim 14, further comprising:
if the index generation request includes information designating types of the values of the text nodes to be indexed, converting the values of the text nodes to be indexed into values of the designated types; and
adding the converted values of the text nodes to the index storing area.

16. The method according to claim 15, further comprising determining whether character strings indicating the values of the text nodes to be indexed are convertible into the values of the designated types,
wherein if character strings indicating the values of the text nodes to be indexed are convertible into the values of the designated types, the converting is executed.

17. The method according to claim 16, wherein if other text nodes that are paired with the text nodes to be indexed and that have the values indicating the types of the values of the text nodes to be indexed are present, it is determined whether the character strings are convertible into the values of the designated types, in accordance with the types of the values of the text nodes to be indexed as indicated by the values of the other text nodes.

18. A computer program product in use for management of a plurality of structured documents and indexes in a database server, the database server including a structured document database, the structured document database including a structured document storing area employed to store the plurality of structured documents and an index storing area employed to store the indexes, the indexes being used to search the structured documents stored in the structured document storing area, the computer program product comprising:
computer-readable program code means for causing the database server to accept an index generation request which is sent from an outside of the database server to direct generation of character string concatenation index and which designates a tag assigned the generated character string concatenation index;
computer-readable program code means for causing the database server to detect, in accordance with the index generation request, the tag designated by the index generation request, from a structured document which is newly stored or has already been stored in the structured document storing area;
computer-readable program code means for causing the database server to concatenate values of a plurality of text nodes depending on the detected tag included in the structured document having the detected tag; and
computer-readable program code means for causing the database server to store in the index storing area the character string concatenation index that includes the values of the plurality of text nodes concatenated and that is assigned to the detected tag.
